(19) United States
(12) Patent Application Publication
(10) Pub. No.: US 2012/0151579 A1
(43) Pub. Date: Jun. 14, 2012

(54) Network Device, Network Packet Processing Method and Computer Readable Storage Medium for Storing Thereof

(75) Inventors: Yi-Shiou Lee, Taipei City (TW); Yi-Shu Huang, Yonghe City (TW); Chih-Hao Hsu, Taipei City (TW); Sheng-De Wang, Taipei City (TW); Chia-Hao Hsu, Lugang Township (TW)

(73) Assignee: INSTITUTE FOR INFORMATION INDUSTRY, Taipei (TW)

(21) Appl. No.: 12/978,857

(22) Filed: Dec. 27, 2010

(30) Foreign Application Priority Data
Dec. 10, 2010 (TW) 099143285

(51) Int. Cl. G06F 12/14; H04L 12/56

(52) U.S. Cl. 726/22; 370/389

(57) ABSTRACT

A network device builds connection with a network through a Network Interface Card (NIC). The network device includes a processor and a storage unit. The processor includes at least one transmission processing core, at least one security core, and a main core. The storage unit stores a packet receiving module and a packet output module. The main core loads the packet receiving module to receive several packets from the network, makes the at least one transmission processing core process the packets for a network transmission and makes the at least one security core check the packets for security. The main core loads the packet output module to output the packets after the at least one transmission processing core processes the packets for network transmission and the at least one security core checks the packets for security.

### RELATED APPLICATIONS

This application claims priority to Taiwan Application Serial Number 099143285, filed Dec. 10, 2010, which is herein incorporated by reference.

### BACKGROUND

1. Technical Field

The present invention relates to a network device, a network packet processing method and a computer readable storage medium for storing thereof.

2. Description of Related Art

Network bandwidths of the network are growing from 10/100 Mbps to 1 G/10 Gbps. As more and more network applications require large network bandwidths, loadings to process network packets for network transmission processes such as transmission processes, check processes, fragment processes, sequencing processes, searching process or other network transmission related processes is becoming more and more important. Research shows that 100% usage rate is needed for Intel Pentium III 1 GHz to process 1 Gbps packets according to TCP protocol, whereas 30% usage rate is needed for Intel Pentium 4 2.4 GHz.

As bandwidth of the network grows, more processing unit resources are required for the network transmission process. Network security has also become increasingly important. However, in the prior art, packets are transmitted without security check, which may cause network security issues.

### SUMMARY

According to one embodiment of this invention, a network device is provided. Each of received packets is processed by at least two cores of the network device for network transmission and security check respectively. The network device builds a connection with a network through a network interface card. The network device includes a processing unit and a storage unit, which are electrically connected to each other. The processing unit includes at least a transmission processing core, at least a security core and a main core. The storage unit stores a packet receiving module and a packet output module. The main core loads the packet receiving module to receive several packets from the network through the network interface card, thereby making the at least one transmission processing core process the packets for network transmission, and making the at least one security core check the packets for security. The main core loads the packet output module to output the packets after the at least one transmission processing core processes the packets for network transmission and the at least one security core checks the packets for security.

According to another embodiment of this invention, a network packet processing method for a processing unit is provided. In the network packet processing method, each of received packets is processed by at least two different cores for network transmission process and security check respectively. The processing unit includes at least one transmission processing core, at least one security core and a main core. The network packet processing method includes: several packets are received. The at least one transmission processing core processes the packets for network transmission. The at least one security core check the packets for security. The packets are output after the at least one transmission processing core processes the packets for network transmission and the at least one security core checks the packets for security.

The network packet processing method may take the form of a computer program product stored on a computer-readable storage medium having computer-readable instructions embodied in the medium.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 illustrates a block diagram of a network device according to one embodiment of this invention; and

FIG. 2 is a flow diagram of a network packet processing method according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

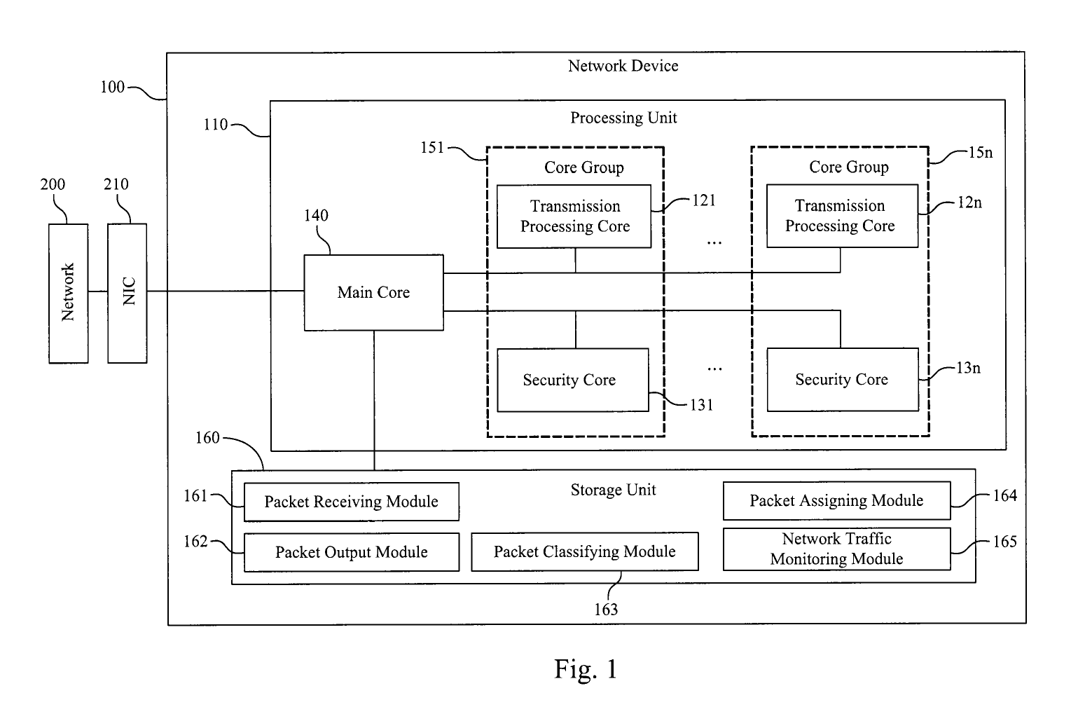

FIG. 1 illustrates a block diagram of a network device according to one embodiment of this invention. Each of the received packets is processed by at least two cores of the network device for network transmission and security check respectively.

The network device 100 builds a connection with a network 200 through a Network Interface Card (NIC) 210. The network device 100 includes a processing unit 110 and a storage unit 160, which are electrically connected to each other. The processing unit 110 includes at least one transmission processing core 121, . . . , 12n, at least one security core 131, . . . , 13n and a main core 140. The storage unit 160 stores a packet receiving module 161 and a packet output module 162. The processing unit 110 may be a multi-core processor with at least three cores, such as Intel Core i7 (which has four cores), CELL (which has nine cores) or any other multi-core processor with at least three cores. The storage unit 160 may be a Read Only Memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives. Wherein, if a ROM or a memory is utilized as the storage unit 160, performance of the network device 100 would be better.

The main core 140 loads the packet receiving module 161 to receive several packets from the network 200 through the NIC 210. The main core 140 makes the at least one transmission processing core 121, . . . , 12n process the packets for network transmission, and makes the at least one security core 131, . . . , 13n check the packets for security. In other embodiments, the main core 140, the at least one transmission processing core 121, . . . , 12n and the at least one security core 131, . . . , 13n may execute functions other than the functions mentioned above, such as processing other data, providing other functions or any other function, which should not be limited in this disclosure.

In some embodiments, the at least one transmission processing core 121, . . . , 12n may process the received packets according to Transmission Control Protocol/Internet Protocol (TCP/IP) or other network transmission related protocols. For example, the at least one transmission processing core 121, . . . , 12n may take the packets for packet check, packet process, packet sequencing, resolving process, packet output or any other network transmission related process.

The main core 140 loads the packet receiving module 161 to make the at least one security core 131, . . . , 13n check the packets for security. In one embodiment of this invention, the at least one security core 131, . . . , 13n may check the packets for security utilizing an Intrusion-detection system (IDS), snort or any other network intrusion prevention system (IPS). In another embodiment of this invention, the at least one security core 131, . . . , 13n may compare the packets with a Rule database to check if the packets are safe. In another embodiment of this invention, the at least one security core 131, . . . , 13n may analyze behaviors of the packets to check if the packets are safe. In other embodiments of this invention, the at least one security core 131, . . . , 13n may utilize other security check methods to check the packets for security, which should not be limited in this disclosure.

In addition, in one embodiment of this invention, the packets may be processed by the at least one transmission processing core 121, . . . , 12n for network transmission first, and then checked for security by the at least one security core 131, . . . , 13n. In another embodiment of this invention, the packets may be checked for security by the at least one security core 131, . . . , 13n first, and then processed by the at least one transmission processing core 121, . . . , 12n for network transmission.

The main core 140 loads the packet output module 162 to output the packets after the at least one transmission processing core 121, . . . , 12n processes the packets for network transmission and the at least one security core 131, . . . , 13n checks the packets for security. Furthermore, the main core 140 may output the packets in different ways according to the result of the security check after the at least one transmission processing core processes the packets for network transmission and the at least one security core checks the packets for security. For example, when the security check result of the packets is safe, the main core 140 outputs the safe packets directly. When the security check result of the packets is suspicious, the main core 140 may withdraw the suspicious packets, not output the suspicious packets or mark the suspicious packets. In other embodiments, the main core 140 may output the suspicious packets in other ways, which should not be limited in this disclosure.

Therefore, each of the packets may be processed for network transmission process and be checked for security in different cores other than the main core 140 respectively, which can reduce the usage rate of the main core 140. Hence, the network device 100 can process the packets faster and breach the packet transmission bottleneck of the network device 100. In other words, the network device may output the packet, which is determined safe, faster.

In some embodiments of this invention, the number of the at least one transmission processing core 121, . . . , 12n is more than one, the number of the at least one security core 131, . . . , 13n is more than one. Each of the transmission processing cores 121, . . . , 12n cooperates with one of the security cores 131, . . . , 13n as a core group 151, . . . , 15n respectively. Each of the packets can be assigned to one of the core groups 151, . . . , 15n respectively, such that the transmission processing core 121, . . . , 12n and the security core 131, . . . , 13n of the same core group respectively to process the packets for network transmission and check the same packets for security. For example, if there is a packet x assigned to the core group 151, the transmission processing core 121 and the security core 131 of the core group 151 respectively do a network transmission process and a security check to the packet x. Each of the core groups 151, . . . , 15n comprises one of the transmission processing cores 121, . . . , 12n and one of the security cores 131, . . . , 13n, which are physically located next to each other on the processing unit. In some embodiments, any two cores, which are next to each other on the processing unit 110, may be assigned to form a core group, wherein one of the two cores is taken as the transmission processing core, and the other one is taken as the security core. Since each of the packets is processed by the two cores, which are physically located next to each other, for the network transmission and the security check, time for transmitting the packets between the cores of the same core group can be saved. Therefore, the network device 100 can do network transmission process and security check more quickly. The packets can be respectively processed by several core groups 151, . . . , 15n, such that the network device 100 can handle packets transmitted with higher bandwidth.

In some embodiments of this invention, the storage unit 160 may further store a packet assigning module 164. The main core 140 loads the packet assigning module 164 to assign the packets to the core groups 151, . . . , 15n. Then, each of the core groups 151, . . . , 15n processes the assigned packets for network transmission and checks the same packets for security. Before the packet assignment, the packets may be classified for assignment. Therefore, the storage unit 160 may further store a packet classifying module 163. The main core 140 loads the packet classifying module 163 to classify the packets into several packet groups according to the network transmission information of the packets.

Wherein, the network transmission information of the packets may include source IP addresses of the packets, destination IP addresses of the packets, source port numbers of the packets, destination port numbers of the packets or other network transmission related information. In one embodiment of this invention, the main core 140 may classify the packets with the same (source or destination) IP address into the same packet group. In another embodiment of this invention, the main core 140 may classify the packets with the same (source or destination) port number into the same packet group. In another embodiment of this invention, the main core 140 may classify the packets with the same (source or destination) port number and IP address into the same packet group. In other embodiments, the main core 140 may classify the packets according to other network transmission related information, which should not be limited in this disclosure. Then, the main core 140 loads the packet assigning module 164 to assign the packets to one of the core groups according to the classified packet groups, such that each of the core groups 151, . . . , 15n does network transmission process and security check to the assigned packets. Wherein, the packets of the same packet group may be assigned to the same core group for network transmission process and security check. Therefore, since the packets of the same packet group may be similar, the core groups 151, . . . , 15n may process the packets faster utilizing the similarity.

In addition, to balance the loading of the core groups 151, . . . , 15n, the network device 100 may monitor transmission network traffic of the packet groups and re-assign the packet group to the core groups 151, . . . , 15n. Hence, the storage unit 160 may further store a network traffic monitoring module 165. The main core 140 loads the network traffic monitoring module 165 to monitor network traffic of the packet groups. Then, the main core 140 can load the packet assigning module 164 to re-assign the relation between the core groups and the packet groups according to the network traffic of the packet groups. In other embodiments, other load balancing method can be utilized for assignment of the packets, which should not be limited in this disclosure. The main core 140 may further record the network traffic of the packet groups and the core groups, which the packet groups are assigned to, into an assignment table. Therefore, the loadings of the core groups 151, . . . , 15n can be balanced, which makes the network device able to process more packets.

In some embodiments of this invention, if the number of the at least one transmission processing core 121, . . . , 12n is more than one, the storage unit 160 further stores a packet assigning table. When the main core 140 makes the transmission processing cores 121, . . . , 12n to process the packets for network transmission, assignment relations between the packets and the transmission processing cores 121, . . . , 12n are recorded in the packet assigning table. In another embodiment, if each of the core groups 151, . . . , 15n is formed by one of the transmission processing cores 121, . . . , 12n and one of the security cores 131, . . . , 13n, the information of the core group, which each of the packets is assigned to, can be recorded in the packet assigning table.

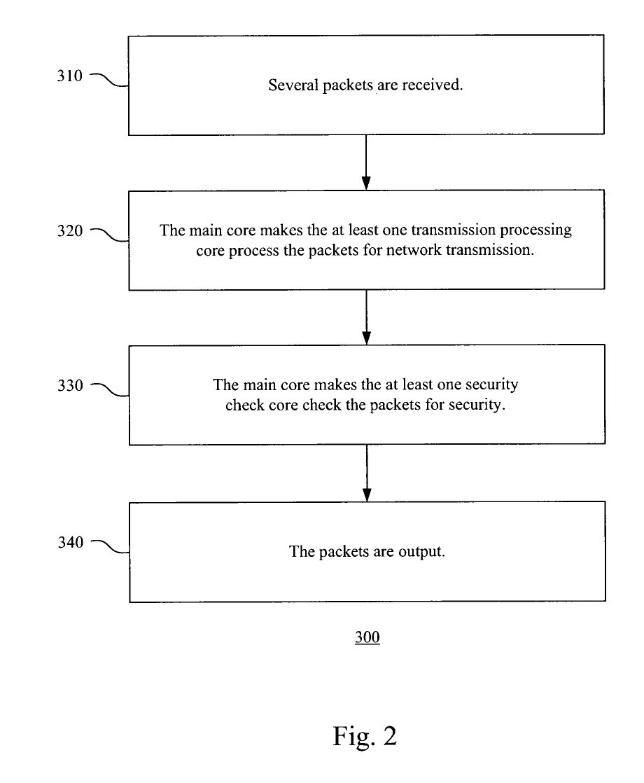

FIG. 2 is a flow diagram of a network packet processing method according to another embodiment of this invention. The network packet processing method may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

The network packet processing method is applied to a processing unit. In the network packet processing method, each of received packets is processed by at least two different cores for the network transmission process and the security check respectively. The processing unit includes at least one transmission processing core, at least one security core and a main core. The network packet processing method 300 includes:

In step 310, several packets are received through a network.

In step 320, the main core makes the at least one transmission processing core process the packets for network transmission.

In step 330, the main core makes the at least one security core check the packets for security.

In step 340, the main core outputs the packets after the at least one transmission processing core processes the packets for network transmission and the at least one security core checks the packets for security.

In detail, in step 320, the at least one transmission processing core may process the received packets according to TCP/IP or other network transmission related protocols for the network transmission process.

In step 330, the at least one security core may check the packets for security utilizing an Intrusion-detection system (IDS), snort. Besides, in the step 330, the at least one security core may check the packets for security by comparing the packets with a signature database or analyzing behaviors of the packets. In other embodiments of this invention, the at least one security core may utilize other security check method to check the packets for security, which should not be limited in this disclosure. Besides, the step 320 may be executed after the step 330, which should not be limited in this disclosure.

In some embodiment of step 340, the packets may be output in different ways according to the result of the security check. For example, when the security check result of the packets is safe, the main core outputs the safe packets directly. When the security check result of the packets is suspicious, the main core may withdraw, not output or mark the suspicious packets. In other embodiments, the main core may output the suspicious packets in other ways, which should not be limited in this disclosure.

If the number of the at least one transmission processing core is more than one and the number of the at least one security core is more than one, each of the transmission processing cores may cooperates with one of the security cores as a core group respectively. Then, the transmission processing core and the security core of the same core group respectively to process the packets for network transmission and check the same packets for security. Besides, each of core groups is formed by the transmission processing core and the security core, which are physically located next to each other on the processing unit.

Before step 320 and step 330, the network packet processing method 300 may further includes the step of assigning one of the transmission processing cores and one of the security cores to form a core group, and assigning the packets to the formed core group. Wherein, the packets may be classified into several packet groups for assignment. Then, the transmission processing core and the security core of the same core group can process the packets for network transmission and check the same packets for security respectively on the same packet. In addition, the network transmission information of the packets can be utilized as factors for assignment. The network transmission information of the packets may include source IP addresses of the packets, destination IP addresses of the packets, port numbers of the packets or other network transmission related information. Then, the main core assigns the packets to the core groups according to the packet groups for network transmission process and security check. Wherein, packets of the same packet group are assigned to the same core group.

In addition, in order to balance the loading of the core groups, the main core may re-assign the packet groups to different core groups. Hence, network traffic of the packet groups may be monitored. The relation between the core groups and the packet groups may be re-assigned according to the network traffic of the packet groups. For example, the packet groups with higher network traffic may be re-assigned to the core groups with lower loadings. In addition, the network traffic of the packet groups and the core groups, which the packet groups are assigned to, may be recorded into an assignment table. Therefore, the loadings of the core groups can be balanced, which makes the network device able to process more packets.

In one embodiment of step 310, a packet assigning table may be provided. When the main core makes the transmission processing cores to process the packets for network transmission, assignment relations between the packets and the transmission processing cores are recorded in the packet assigning table.

Above all, different cores can do network transmission process and security check of a same packet respectively, which reduces usage rates of the cores. Hence, packets can be processed faster, which breaches the packet transmission bottleneck. Therefore, more packets can be output with better security guarantee.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A network device, wherein the network device builds a connection with a network through a network interface card, the network device comprises:
a processing unit comprising at least a transmission processing core, at least a security core and a main core; and
a storage unit electrically connected to the processing unit, wherein the storage unit stores a packet receiving module and a packet output module,
wherein the main core loads the packet receiving module to receive a plurality of packets from the network through the network interface card, thereby making the at least one transmission processing core process the packets for network transmission and making the at least one security core check the packets for security, and the main core loads the packet output module to output the packets after the at least one transmission processing core processes the packets for network transmission and the at least one security core checks the packets for security.

2. The network device of claim 1, wherein the number of the at least one transmission processing core is more than one, the number of the at least one security core is more than one, and each of the transmission processing cores cooperates with one of the security cores as a core group to process the packets for network transmission and check the same packets for security respectively.

3. The network device of claim 2, wherein each of the core groups comprises one of the transmission processing cores and one of the security cores, and the transmission processing core and the security core in each of the core groups are physically located next to each other on the processing unit.

4. The network device of claim 1, wherein the number of the at least one transmission processing core is more than one, the at least one security core is more than one, each of the transmission processing cores cooperates with one of the security cores as a core group, the storage unit further stores a packet assigning module, and the main core loads the packet assigning module to assign the packets to the core groups, such that each of the core groups processes the assigned packets for network transmission and checks the same packets for security.

5. The network device of claim 1, wherein the number of the at least one transmission processing core is more than one, the number of the at least one security core is more than one, each of the transmission processing cores cooperates with one of the security cores as a core group;
wherein the storage unit further stores a packet classifying module and a packet assigning module; and
wherein the main core loads the packet classifying module to classify the packets into a plurality of packet groups according to the network transmission information of the packets, and the main core loads the packet assigning module to assign the packets to one of the core groups according to the packet groups, such that each of the core groups processes the assigned packets for network transmission and checks the same packets for security.

6. The network device of claim 5, wherein the storage unit further stores a network traffic monitoring module, the main core loads the network traffic monitoring module to monitor network traffic of the packet groups, and the main core loads the packet assigning module to re-assign the relation between the core groups and the packet groups according to the network traffic of the packet groups.

7. The network device of claim 1, wherein the number of the at least one transmission processing core is more than one, the storage unit further stores a packet assigning table, and
when the main core makes the transmission processing cores to process the packets for network transmission, assignment relations between the packets and the transmission processing cores are recorded in the packet assigning table.

8. The network device of claim 1, wherein after the at least one transmission processing core processes the packets for network transmission and the at least one security core checks the packets for security,
the main core outputs the safe packets when a security check result of the packets is safe, and
the main core withdraws the suspicious packets , does not output the suspicious packets or marks the suspicious packets when the security check result of the packets is suspicious.

9. A network packet processing method for a processing unit, wherein the processing unit comprises at least one transmission processing core, at least one security core and a main core, the network packet processing method comprises:
receiving a plurality of packets;
making the at least one transmission processing core process the packets for network transmission;
making the at least one security core check the packets for security; and
outputting the packets after the at least one transmission processing core processes the packets for network transmission and the at least one security core checks the packets for security.

10. The network packet processing method of claim 9, wherein the number of the at least one transmission processing core is more than one, the number of the at least one security core is more than one, and each of the transmission processing cores cooperates with one of the security cores as a core group to process the packets for network transmission and check the same packets for security respectively.

11. The network packet processing method of claim 10, wherein each of the core groups comprises one of the transmission processing cores and one of the security core, and the transmission processing core and the security core in each of the core groups are physically located next to each other on the processing unit.

12. The network packet processing method of claim 9, wherein the number of the at least one transmission processing core is more than one, the at least one security core is more than one, each of the transmission processing cores cooperates with one of the security cores as a core group, wherein the network packet processing method further comprises:
assigning the packets to the core groups, such that each of the core groups processes the assigned packets for network transmission and checks the same packets for security.

13. The network packet processing method of claim 9, wherein the number of the at least one transmission processing core is more than one, the number of the at least one security core is more than one, each of the transmission processing cores cooperates with one of the security cores as a core group, the network packet processing method further comprises:
classifying the packets into a plurality of packet groups according to the network transmission information of the packets; and
assigning the packets to one of the core groups according to the packet groups, such that each of the core groups processes the assigned packets for network transmission and checks the same packets for security.

14. The network packet processing method of claim 13 further comprising:
monitoring network traffic of the packet groups; and
re-assign the relation between the core groups and the packet groups according to the network traffic of the packet groups.

15. The network packet processing method of claim 13, wherein the network transmission information of the packets comprises IP addresses of the packets or ports of the packets.

16. The network packet processing method of claim 9, wherein the number of the at least one transmission processing core is more than one, the network packet processing method further comprises:
storing a packet assigning table; and
when making the transmission processing cores to process the packets for network transmission, recording assignment relations between the packets and the transmission processing cores in the packet assigning table.

17. The network packet processing method of claim 9 further comprising:
after the at least one transmission processing core processes the packets for network transmission and the at least one security core checks the packets for security, outputting the safe packets when a security check result of the packets is safe, and withdrawing the suspicious packets, not outputting the suspicious packets or marking the suspicious packets when the security check result of the packets is suspicious.

18. A computer readable storage medium with a computer program to execute a network packet processing method for a processing unit, wherein the processing unit comprises at least one transmission processing core, at least one security core and a main core, the network packet processing method comprises:
receiving a plurality of packets;
making the at least one transmission processing core process the packets for network transmission;
making the at least one security core check the packets for security; and
outputting the packets after the at least one transmission processing core processes the packets for network transmission and the at least one security core checks the packets for security.
